(19) United States
(12) Patent Application Publication
(10) Pub. No.: US 2024/0263077 A1
(43) Pub. Date: Aug. 8, 2024

(54) CONTINUOUS PROCESS PYROLYSIS SYSTEM

(71) Applicant: EARTH SYSTEMS CONSULTING PTY LTD, Hawthorn, Victoria 3122 (AU)

(72) Inventors: Adrian Lindsay MORPHETT, Mansfield, Victoria 3722 (AU); Ricky Vitas Dent, Templestowe, Victoria 3106 (AU); Philip John SANDERSON, Castlemaine, Victoria 3450 (AU)

(21) Appl. No.: 18/566,476

(22) PCT Filed: May 30, 2022
(86) PCT No.: PCT/AU2022/050523

§ 371 Date: Dec. 1, 2023

(30) Foreign Application Priority Data
Jun. 3, 2021 (AU) 2021203638

(51) Int. Cl. C10B 49/04; B01J 6/00; C10B 53/02

(52) U.S. Cl. CPC C10B 49/04; B01J 6/008; C10B 53/02

(57) ABSTRACT

The invention provides apparatus and method of pyrolysing feedstock to produce char. A feedstock advancing mechanism in a lower portion of a substantially sealed reaction chamber advances the feedstock laterally along the lower portion as it pyrolyses in its progression from the proximal end to the distal end. Char is discharged from the distal end of the reaction chamber. A control system controls at least the flow rate of oxygen containing gas entering the chamber via the inlet port in response to the temperature measurements in the reaction chamber so that the temperature measurements are appropriate for the production of char from the feedstock and so that a zone of volatile gas combustion is established in the headspace, involving essentially complete consumption of all incoming free oxygen in the headspace without contacting the feedstock.

### FIELD

The present invention relates to pyrolysers, in particular to a continuous process pyrolyser for the production of char being an improvement on a batch process pyrolyser described in PCT/AU2013/000969, the disclosures of which are incorporated herein in their entirety.

### BACKGROUND

PCT/AU2013/000969 describes a batch process pyrolyser suitable for the production of char from biomass, which involves the fundamental idea of the creation of a zone of volatile gas combustion in an upper portion of the reaction chamber above and away from the top portion of the feedstock involving essentially complete combustion of all incoming oxygen. An outlet is disposed in a lower portion of the reaction chamber enabling oxygen-depleted gases generated within the reaction chamber to percolate downwards through the pyrolysing feedstock, transferring heat to the bulk of the batch of pyrolysing feedstock. The possibility of continuous processes are mentioned therein without exemplification.

The inventors have found that development of a reliable continuous process is not straightforward in achieving an aim of robust performance with a variety of feedstocks. By extensive experimentation, the inventors have conceived a design for a continuous process implementing the fundamental idea which has good reliability across a variety of feedstocks.

### SUMMARY OF THE INVENTION

In accordance with a first broad aspect of the invention there is provided an apparatus for drying and pyrolysing a feedstock containing carbonaceous material to produce char, the apparatus including:
a reaction chamber which is substantially sealed except for one or more inlet ports at a distal end of the reaction chamber connectable to a supply of oxygen-containing gas and one or more outlet ports at a proximal end of the reaction chamber for release of gaseous combustion products;
a feedstock feeder to feed the feedstock into the proximal end of the reaction chamber;
a feedstock advancing mechanism in a lower portion of the reaction chamber to advance the feedstock laterally along the lower portion as it pyrolyses in its progression from the proximal end to the distal end;
headspace in the reaction chamber above the pyrolysing feedstock in the lower portion;
a char discharge port to discharge the feedstock after pyrolysing from the distal end of the reaction chamber;
an oxygen flowrate controller for adjusting a flow rate of the oxygen-containing gas through the inlet port;
temperature probes to provide temperature measurements at different heights in the reaction chamber;
a control system operably connected at least with the oxygen flowrate controller and the temperature probes to control at least the flow rate of oxygen containing gas entering the chamber via the inlet port in response to the temperature measurements so that the temperature measurements are appropriate for the production of char from the feedstock and so that a zone of volatile gas combustion is established in the headspace, involving essentially complete consumption of all incoming free oxygen in the headspace without contacting the feedstock; and
an ignition mechanism for providing an initial source of heat into the reaction chamber to achieve a self-sustaining pyrolysing steady state maintained by combustion of volatile gases from the pyrolysing feedstock.

In one embodiment, there is at least one temperature probe in an upper part of the headspace and at least one temperature probe in a middle part of the headspace. There may also be at least one temperature probe in a lower part of the headspace close to the pyrolysing feedstock. Multiple temperature probes may be provided along the length of the reaction chamber 5 from the proximal end to the distal end.

In one embodiment, the char discharge port comprises a rotary valve airlock to prevent ingress of air during discharge of the char.

In one embodiment, the feedstock feeder comprises a feed ram adapted to push feedstock through a close-fitting opening into the reaction chamber such that the feed ram acts as a gas seal when in a closed position. The feedstock feeder may comprise a feed chute above the feed ram with a lower opening closable by a chute gate, the feed chute receiving a load of feedstock from above and holding the load while the chute gate is closed and allowing feedstock to fall through the chute gate when the chute gate is open, the chute gate operating in opposition to the feed ram so that when the feed ram is open the chute gate is closed, thereby continuing to provide a gas seal.

In one embodiment, the feedstock advancing mechanism comprises at least one screw conveyor operating in a channel in the lower portion of the chamber to advance the feedstock by rotation of the screw conveyor. The screw conveyor may comprise a hollow shaft through which a cooling fluid is passed to prevent overheating of the screw conveyor. The cooling fluid may be air, oil or other fluid.

In one embodiment, the one or more inlet ports at the distal end of the reaction chamber are located relatively high in the headspace and/or comprise a baffle or diffuser so as to prevent the entering oxygen-containing gas impinging onto the hot pyrolysed feedstock below.

In accordance with a second broad aspect of the invention there is provided method of drying and pyrolysing a feedstock containing carbonaceous material to produce char using the apparatus of the first broad aspect or any of its embodiments, the method including the steps of:
loading feedstock into the feedstock feeder and operating the feedstock feeder to feed the feedstock into the proximal end of the reaction chamber as required;
operating the feedstock advancing mechanism to progress the feedstock from the proximal end to the distal end;
operating the char discharge port to discharge the feedstock after pyrolysing from the distal end of the reaction chamber;
operating the control system to control at least the flow rate of oxygen containing gas entering the chamber via the inlet port in response to the temperature measurements so that the temperature measurements are appropriate for the production of char from the feedstock and so that a zone of volatile gas combustion is established in the headspace, involving essentially complete consumption of all incoming free oxygen in the headspace without contacting the feedstock; and
operating the ignition mechanism during a start-up period to heat the reaction chamber to a self-sustaining steady state maintained by combustion of volatile gases from the pyrolysing feedstock.

### BRIEF DESCRIPTION OF DRAWINGS

FIG. 1 is a cross-section of a pyrolyser according to an embodiment of the first aspect of the invention as operated in an embodiment of the second aspect of the invention;

### DETAILED DESCRIPTION OF EMBODIMENTS

Embodiments of the current invention will now be described.

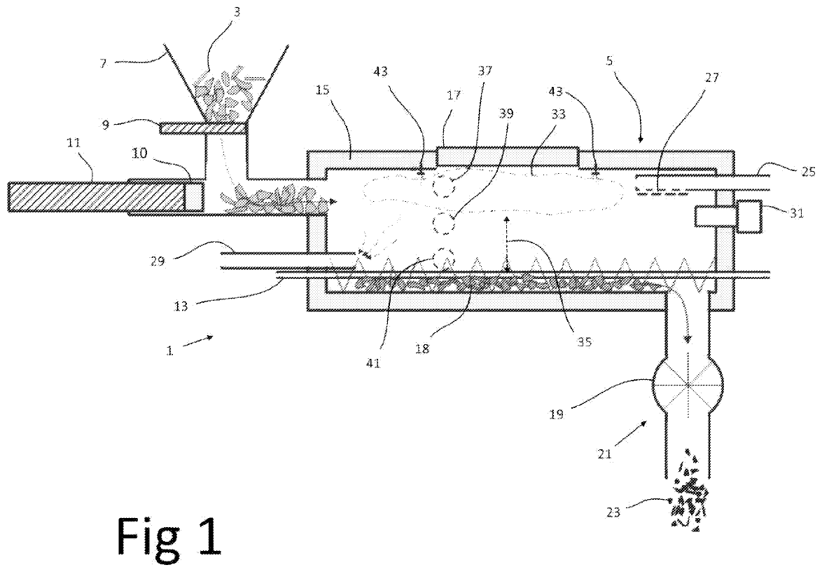

Referring to FIG. 1, apparatus 1 is adapted to pyrolyses feedstock containing carbonaceous material to produce char. Suitable carbonaceous material includes biomass or waste matter such as natural and manufactured wood and woody wastes, agricultural wastes such as straw (loose or pelletised), various husks, hulls, pits, leaves, shells and the like, chemically-contaminated materials such as hydrocarbon and pesticide-contaminated soil and wood, and biohazardous waste including biosolids, sewage sludge, diseased plant matter, weed seeds and other material containing high-risk pathogens.

A feedstock feeder includes a feed chute 7 gated by a knife gate 9 disposed above a feed ram 11 operating within a closely fitting opening at a proximal end of the reaction chamber 5. Feed ram 11 has a diameter of about 300 mm. During continuous operation, feedstock 3 containing carbonaceous material is loaded into the feed chute 7 as required and dropped as required by opening the knife gate 9 into the path of feed ram 11 which operates as required to deliver feedstock into the proximal end of reaction chamber 5 through a close-fitting opening. The feed ram 11 is disposed within the close-fitting opening which also acts as a gas seal when in the closed position. Knife gate 9 operates in opposition to feed ram 11 so that when feed ram 11 is open knife gate 9 is closed, thereby providing an “air lock” function and continuing to provide a gas seal. Front face 10 of feed ram 11 is made of a high-temperature insulating material as it is exposed to the heat of the process when in the closed position.

Reaction chamber 5 is constructed from steel alloy and is internally lined with thermal insulation such as aluminosilicate mineral brick and blanket. Approximate dimensions of the reaction chamber in this example are 500 mm by 3000 mm by 300 mm. The introduced feedstock 18 is moved through the reaction chamber 5 from its entry at the proximal end to a distal end via a screw conveyor 13 of controllable speed which has a hollow fluid-cooled shaft. The fluid may be air, oil or other suitable fluid. Auger 13 typically transports feedstock 18 at a feed rate of approximately 10 mm/s. This corresponds to approximately 100 kg per hour processing of feedstock material in this example.

Reaction chamber 5 is internally lined with thermal insulation 15. Outlet port 29 is located at the proximal end of reaction chamber 5 at a lower part of the headspace above the advancing feedstock 18, away from the zone of combustion 33 to be described below. Outlet port 29 has an internal diameter of about 150 mm. Outlet port 29 is permanently open at least during steady-state operation so that reaction chamber 5 operates at ambient pressure. An explosion pressure relief device in the form of a pressure-activated hatch 17 is fitted to safely relieve pressure in the event of a gas explosion caused by uncontrolled combustion of feedstock material.

Hot, pyrolysed feedstock as char 23 exits the char discharge port 21 at the distal end of the reaction chamber 5 via rotary valve airlock 19 to prevent ingress of ambient air. Hot char 23 is then required to be cooled or quenched to a safe temperature via an appropriate cooling scheme (not shown).

Oxygen-containing gas enters the reaction chamber via inlet port 25 located in the headspace above the advancing feedstock 18 in an upper portion of headspace at the distal end of reaction chamber 5. The inlet port may incorporate a diffuser or baffle 27 to minimise the impingement of oxygen-containing gas onto the hot pyrolysed product in order to avoid the loss of pyrolysed product by combustion. A volatiles combustion zone 33 is established in the upper portion of the reaction chamber where volatiles driven off the pyrolyzing material are consumed via combustion, providing essentially complete consumption of all incoming free oxygen in the combustion zone 33 without contacting the advancing feedstock 18, while providing heat to drive the pyrolysis of the advancing feedstock 18.

Temperature measurements in the upper 37, lower 41 and middle 39 regions of the headspace in the reaction chamber 5 are used to determine the process conditions and inform appropriate flow control of the oxygen-containing gas so that temperatures stay within target ranges and a separation zone 35 is maintained between the gaseous volatiles combustion zone 33 and the advancing pyrolyzing feedstock 18. Combustion product gases exit from a lower region of the reaction chamber 5 via an outlet port 29 at the proximal end, thereby creating a net counter-current flow profile between the solid and gas phases along the length of the reaction chamber. Water spray devices 43 may be used to quickly reduce maximum temperatures in the reaction chamber in the case of excessively dry or energy-dense feedstock.

The target maximum for temperature measurements in the upper region 37 of the headspace is typically 800° C. Multiple measurement points may be used along the length of the reaction chamber 5.

Temperature range in the middle region 39 of the headspace is typically maintained in the range 550° ° C. to 650° C. Again, multiple measurement points may be used along the length of reaction chamber 5.

Temperature range in the lower region 41 of the headspace is typically maintained in the range 250° ° C. to 500° ° C. along most of the length of the reaction chamber 5. It is desirable to achieve a temperature of between 450° ° C. to 550° C. at a measurement point at the distal end prior to solids leaving the reaction chamber 5.

A control system (not shown) such as a programmable controller, of which many kinds are known in the art, may be used to operate at least an oxygen flow rate controller in response at least to the temperature probes in order to maintain the desired conditions for pyrolysis and in particular ensuring the zone 33 is maintained separated by a separation zone 35 from the pyrolysing advancing feedstock 18. As will be appreciated, the particular conditions to ensure such desired conditions and separation can be ascertained during a design phase by taking measurements within the reaction chamber of oxygen content (by installing oxygen sensors or taking gas samples to analyse externally) under various conditions of the temperature measurements, oxygen flow rate, feedstock feed rate and feedstock type and programming the control system with the appropriate algorithm to respond to the temperature measurements and other parameters in use.

As described above, according to the invention there is a lateral progression of feedstock from the proximal to the distal end under the headspace, with the inlet port and outlet ports at opposite lateral ends of the reaction chamber. This arrangement does not provide the feature of heat transfer by percolation of the combustion gases downwards through the pyrolysing feedstock in the batch process described in PCT/AU2013/000969. Nonetheless, it has been found that highly efficient pyrolysis of the feedstock is provided as a relatively thin layer of feedstock is heated from above by the combustion gases in the zone above the feedstock in the headspace. Further, the positioning of the inlet port at the distal end and the outlet port at the proximal end providing a direction of gas flow opposing the direction of progression of the feedstock has been found to provide a reliably stable pyrolysis of a variety of feedstocks. By contrast, placing the inlet port at the proximal end and the outlet port at the distal end has been found to result in undesirable instabilities.

Persons skilled in the art will also appreciate that many variations may be made to the invention without departing from the scope of the invention, which is determined from the broadest scope and claims.

For example, the feedstock advancing mechanism provided by the screw conveyor in the above-described embodiment could also be achieved via other means, (eg a chain grate or fluidized bed) as would be known to those skilled in the art.

Further, the embodiment above describes a control system which adjusts the oxygen flow rate in response to temperature measurements at different levels within the headspace of the reaction chamber 5. In other embodiments, additional parameters may be used in the operation of the control system, such as the feedstock feed rate.

The dimensions and other parameters provided above in the description of the exemplified embodiment are for the purposes of full description of that embodiment and of course can be varied as appropriate to the scale of the application and the feedstock material at hand, as would be understood by a person skilled in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

1. An apparatus for drying and pyrolysing a feedstock containing carbonaceous material to produce char, the apparatus including:
a reaction chamber which is substantially sealed except for one or more inlet ports at a distal end of the reaction chamber connectable to a supply of an oxygen-containing gas and one or more outlet ports at a proximal end of the reaction chamber for release of gaseous combustion products;
a feedstock feeder to feed the feedstock into the proximal end of the reaction chamber;
a feedstock advancing mechanism in a lower portion of the reaction chamber to advance the feedstock laterally along the lower portion as it pyrolyses in its progression from the proximal end to the distal end;
headspace in the reaction chamber above a pyrolysing feedstock in the lower portion;
a char discharge port to discharge the feedstock after pyrolysing from the distal end of the reaction chamber;
an oxygen flowrate controller for adjusting a flow rate of the oxygen-containing gas through the inlet port;
temperature probes to provide temperature measurements at different heights in the reaction chamber;
a control system operably connected at least with the oxygen flowrate controller and the temperature probes to control at least a flow rate of oxygen containing gas entering the reaction chamber via the inlet port in response to the temperature measurements so that the temperature measurements are appropriate for the production of a char from the feedstock and so that a zone of volatile gas combustion is established in the headspace, involving consumption of incoming free oxygen in the headspace without contacting the feedstock; and
an ignition mechanism for providing an initial source of heat into the reaction chamber to achieve a self-sustaining pyrolysing steady state maintained by combustion of volatile gases from the pyrolysing feedstock.

2. The apparatus of claim 1, wherein there is at least one temperature probe in an upper part of the headspace and at least one temperature probe in a middle part of the headspace.

3. The apparatus of claim 2, wherein there is at least one temperature probe in a lower part of the headspace close to the pyrolysing feedstock.

4. The apparatus of claim 1, wherein multiple temperature probes are provided along a length of the reaction chamber from the proximal end to the distal end.

5. The apparatus of claim 1, wherein the char discharge port comprises a rotary valve airlock to prevent ingress of air during discharge of the char.

6. The apparatus of claim 1, wherein the feedstock feeder comprises a feed ram configured to push feedstock through a close-fitting opening into the reaction chamber such that the feed ram is configured as a gas seal when in a closed position.

7. The apparatus of claim 6, wherein the feedstock feeder comprises a feed chute above the feed ram with a lower opening closable by a chute gate, the feed chute configured to receive a load of feedstock from above and further configured to hold the load of feedstock while the chute gate is closed and further configured to allow feedstock to fall through the chute gate when the chute gate is open, the chute gate configured to operate in opposition to the feed ram so that when the feed ram is open the chute gate is closed, thereby continuing to provide a gas seal.

8. The apparatus of claim 1, wherein the feedstock advancing mechanism comprises at least one screw conveyor configured to operate in a channel in the lower portion of the reaction chamber to advance the feedstock by rotation of the screw conveyor.

9. The apparatus of claim 8, wherein the screw conveyor comprises a hollow shaft through which a cooling fluid may be passed to prevent overheating of the screw conveyor.

10. The apparatus of claim 9, wherein the cooling fluid is selected from the group consisting of air and oil.

11. The apparatus of claim 1, wherein the one or more inlet ports at the distal end of the reaction chamber are located relatively high in the headspace and the one or more inlet ports is configured to prevent any entering oxygen-containing gas impinging onto any of the pyrolysed feedstock below.

12. A method of using the apparatus of claim 1 for drying and pyrolysing the feedstock, the method comprising the steps of:
loading feedstock into the feedstock feeder and operating the feedstock feeder to feed the feedstock into the proximal end of the reaction chamber;
operating the feedstock advancing mechanism to progress the feedstock from the proximal end to the distal end;
operating the char discharge port to discharge the feedstock after pyrolysing from the distal end of the reaction chamber;
operating the control system to control at least the flow rate of oxygen containing gas entering the reaction chamber via the inlet port in response to the temperature measurements so that the temperature measurements are appropriate for the production of the char from the feedstock and so that a zone of volatile gas combustion is established in the headspace, involving essentially complete consumption of all incoming free oxygen in the headspace without contacting the feedstock; and
operating the ignition mechanism during a start-up period to heat the reaction chamber to a self-sustaining steady state maintained by combustion of volatile gases from the pyrolysing feedstock.
